(19) United States
(12) Patent Application Publication
(10) Pub. No.: US 2006/0146740 A1
(43) Pub. Date: Jul. 6, 2006

(54) Method and apparatus for delivering user level information

(76) Inventors: Arnold Sheynman, Northbrook, IL (US); Satish V. Brahme, Lindenhurst, IL (US); Michael L. Charlier, Palatine, IL (US); Mark E. Pecen, Palatine, IL (US)

Correspondence Address: LAW OFFICES OF CHARLES W. BETHARDS, LLP, P.O. BOX 1622, COLLEYVILLE, TX, 76034, US

(21) Appl. No.: 11/026,451

(22) Filed: Dec. 30, 2004

(51) Int. Cl. H04H 1/00; H04J 3/24

(52) U.S. Cl. 370/312

(57) ABSTRACT

A method (300) of delivering user level information, such as an emergency message, using wireless channels, includes embedding user level information in wireless system control message (309) and broadcasting the control message (311) including the user level information in accordance with a protocol for one or more control messages in a wireless communication system. The method may be implemented in a corresponding transmitting unit (400) and the message can be received by a communication unit (500).

### FIELD OF THE INVENTION

This invention relates in general to communication systems, and more specifically to a method and apparatus for delivering messages, such as emergency warning messages, to the public.

### BACKGROUND OF THE INVENTION

Various approaches exist for delivering short messages to the public, however these all have their respective limitations. For example, the known Global System for Mobile (GSM) standards define a Short Message Service (SMS). SMS Cell Broadcast is defined in Phase 2 of the GSM standard in 3GPP TS 23.041 “Cell Broadcast service (CBS)” and 3GPP TS 04.12 “Short message service Cell Broadcast (SMSCB) support on the mobile radio interface”. SMS Cell Broadcast is designed for broadcasting messages to multiple users. However SMS as defined by these standards requires an operational cellular system and is typically only made available by carriers and service providers in exchange for a subscription fee from consumers. Subscribers to the service are provided news, traffic reports, weather forecasts and the like. Since many people do not have a subscription to SMS cell broadcast service a large number of individuals will not receive the short message. This may be particularly problematic if the message is an emergency warning message.

### BRIEF DESCRIPTION OF THE DRAWINGS

The accompanying figures where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 depicts, in a simplified and representative form, a system level diagram of a communications system for delivering user level information messages;

FIG. 2 depicts, in a simplified and representative form, an alternative system level diagram of a system for delivering user level information messages;

FIG. 3 illustrates a simplified flow chart of a method of delivering user level information messages;

FIG. 4 depicts an exemplary block diagram of a transmitter for delivering user level information messages;

FIG. 5 depicts an exemplary block diagram of a communication unit for receiving user level information messages;

FIG. 6 shows a synchronization protocol structure for a Wideband Code Division Multiple Access (W-CDMA) system;

FIG. 7 shows a synchronization data structure for a Global System for Mobile (GSM) system; and

FIG. 8 shows a data frame according to a protocol for a GSM system.

### DETAILED DESCRIPTION

In overview, the present disclosure concerns various methods and apparatus for delivering or broadcasting user level information messages, such as emergency, or warning, or the like to users that typically utilize wireless communications systems for services such as voice and data communications. More particularly various inventive concepts and principles embodied in methods and apparatus for delivering user level information messages with or without an operational communication system, such as a cellular system, are discussed.

The wireless communications systems and corresponding communication units of particular interest are those being deployed and developed such as Global System for Mobile (GSM), Time Division Multiple Access (TDMA), Code Division Multiple Access (CDMA), Wideband CDMA, Universal Mobile Telecommunication Service (UMTS) systems or the like including variations and evolutions of these and other systems that utilize some form of access or overhead channel where communication units, e.g., subscriber devices or units, will migrate to or search for in order to initiate access to the systems. Note that the inventive principles and concepts can also apply to communication units that are using short-range wireless communication capabilities, such as IEEE 802.11 and similar wireless local area network protocols.

As further discussed below, various inventive principles and combinations thereof are advantageously employed to essentially decouple group membership and the location or contact information (mobility) for the various members, thus alleviating various problems associated with known systems while still facilitating setting up sessions with or between groups of users regardless of present locations provided these principles or equivalents thereof are utilized.

The instant disclosure is provided to further explain in an enabling fashion the best modes of making and using various embodiments in accordance with the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms, if any, such as first and second, top and bottom, and the like are used solely to distinguish one from another entity or action without necessarily requiring or implying any actual such relationship or order between such entities or actions.

Much of the inventive functionality and many of the inventive principles are best implemented with or in software programs or instructions and integrated circuits (ICs) such as various forms of processors and application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts according to the present invention, further discussion of such software and ICs, if any, will be limited to the essentials with respect to the principles and concepts of the preferred embodiments.

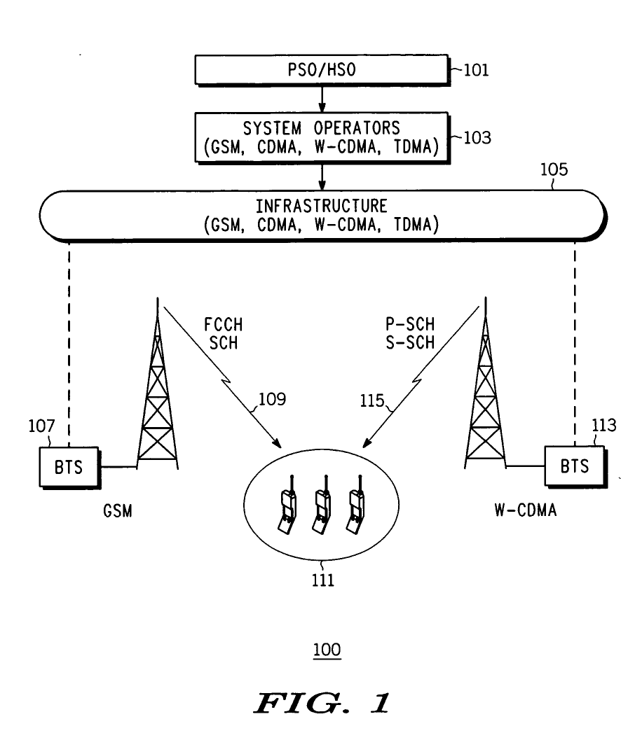

FIG. 1 illustrates, in a simplified and representative form, a system level diagram 100 of a communications system for delivering user level information messages to a population of communication devices, where user level information can be a pointer, such as a phone number, URL, etc, to more information as well as information contained within the message. In FIG. 1, a Public Safety Office or Organization 101, such as the United States Homeland Security Office (HSO) is operably coupled to various communication system or network operators 103. Note that various systems may exist in any given locale and that these systems can use different access technologies and corresponding protocols or air interfaces. For example, these systems can be one or a plurality of GSM, CDMA, W (wideband)—CDMA or UMTS, TDMA, or the like systems with their respective infrastructures 105 and corresponding subscribers.

Each of these systems will typically have a multiplicity of transceivers or Base Transceiver Stations (BTS) (in some systems referred to as Node B transceivers). FIG. 1 shows a BTS 107, e.g., a GSM BTS, transmitting or sending a signal 109 to a multiplicity of communication units (subscriber devices or units, handsets, etc.) 111. Note that in accordance with the concepts and principles discussed in the present disclosure this signal 109 only needs to include certain overhead or access channels, e.g., a Frequency Correction Channel (FCCH) and a Synchronization Channel (SCH) or more specifically signals in accordance with known protocols for one or more of these overhead channels. As will be further discussed and described, the user level information messages or information (e.g., pointer, phone number, URL, or the like in user perceptible or readable form) corresponding to the user level information messages is embedded in one or more of the overhead or access channels, e.g., the SCH channel for GSM cellular systems.

Further depicted is a BTS 113, e.g., a W-CDMA BTS that is transmitting or sending a signal 115 to the population of communication units 111. The signal 115 only needs to include a Primary—Synchronization Channel (P-SCH) and a Secondary—Synchronization Channel (S-SCH) or more specifically signals in accordance with known protocols for one or more of these overhead channels. As noted above, information corresponding to the user level information message or class of user level information message can be embedded in one or more of these overhead or access channels for W-CDMA cellular systems. Because corresponding communication units or subscriber devices will migrate to or seek out the signals on these channels, most of the communication units and users of the units will get the user level information messages. Other systems with other access technologies can similarly embed user level information messages as will become evident with further discussions corresponding to GSM and W-CDMA systems. Note that for user level information messages to be delivered with the system(s) depicted in FIG. 1, the respective communication system(s) must be operational.

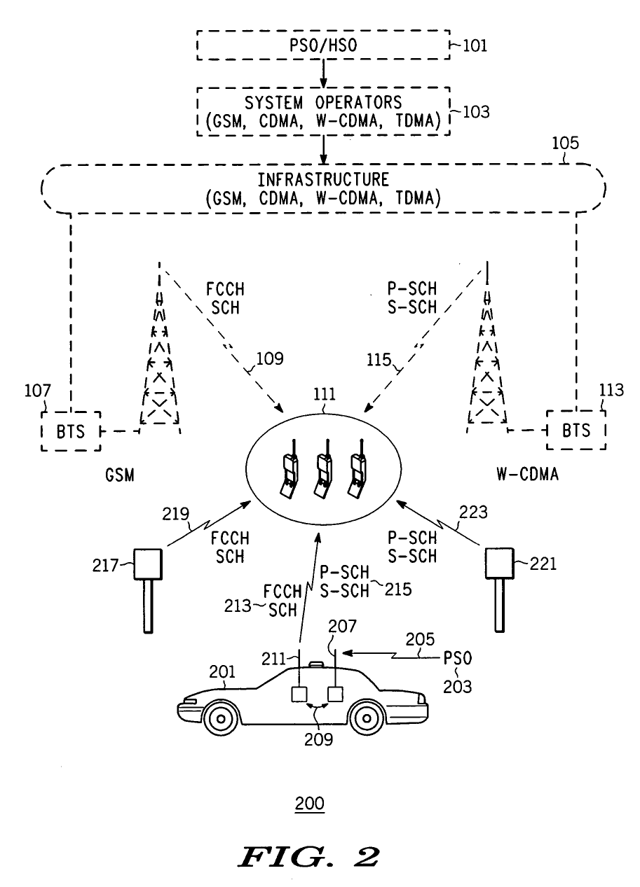

FIG. 2 depicts, in a simplified and representative form, an alternative system level diagram of a system 200 for delivering user level information messages when the communication systems of FIG. 1 are not available or operational. FIG. 2 shows the same population or multiplicity of communication units 111. Also shown is a vehicle 201, such as a public safety vehicle 201 that is receiving a signal 205, comprising a user level information message, such as a warning or emergency message from a Public Safety Office or Officer (PSO) 203. In these circumstances, the signal 205 would typically be received via a Public Safety radio 207 and corresponding channel. The user level information message can be passed or forwarded (reflected by arrow 209) to a transmitter 211 that can be used to assist with delivery of the user level information message or corresponding indication of the message. The vehicle can travel about the appropriate area or locale and broadcast the appropriate signals to deliver the message to corresponding users. In this instance, the transmitter is shown transmitting one or both of the GSM access channels, e.g., FCCH and SCH 213, and W-CDMA access channels, e.g., P-SCH and S-SCH 215 or signals corresponding to the respective protocols for these channels. Note that the transmitter does not send the Broadcast Control Channel (BCCH) for GSM systems or the Primary Common Pilot Channel (P-CPICH) or Primary Common Control Physical Channel (P-CCPCH) in W-CDMA systems. Thus as is known, communication units or handsets 111 will not camp on the signal from this transmitter 211.

Further depicted in FIG. 2 are one or more fixed location transmitters 217 sending a GSM based signal 219 and one or more fixed location transmitters 221 sending a W-CDMA based signal 223. It is expected that a relatively inexpensive auxiliary network can be established with such transmitters, where a given transmitter would be able to transmit multiple signals corresponding to multiple access technologies (concurrently or sequentially) in the event that a vehicle, e.g. vehicle 201, is not available to provide delivery of the user level information messages. Note that transmitters in the vehicle or fixed location transmitters can send appropriate signals corresponding to the protocols for whatever systems are deployed in a given location.

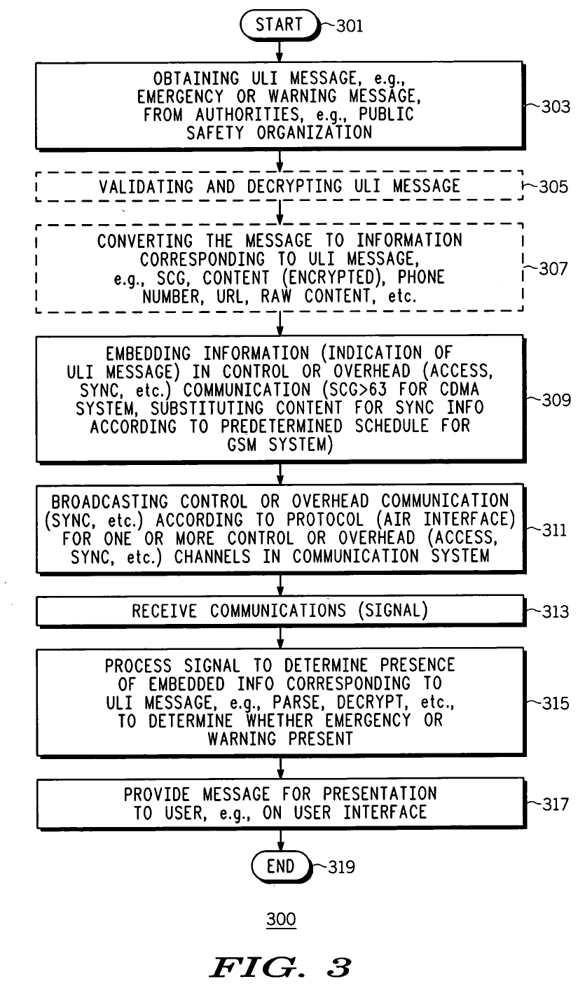

FIG. 3 illustrates a simplified flow chart of a method 300 of delivering user level information messages, such as emergency warning messages, using, for example, cellular channels. Generally, the method comprises embedding user level information in a wireless system control message and broadcasting the control message in accordance with a protocol for one or more such control messages in a wireless communication system. The method may comprise embedding information corresponding to the user level information messages in an overhead or access communication, such as a synchronization communication, and broadcasting the overhead communication including the information in accordance with a protocol for one or more overhead channels in a cellular or other communication system. The method 300 can be practiced in the systems of FIG. 1 or FIG. 2 or more particularly the various transmitters and communication units shown in those FIGs. and further described below or other systems and apparatus suitably configured and arranged.

The method 300 begins at 301 with 303 obtaining a user level information message, such as an emergency message, from, for example, an authority, such as a public safety organization (PSO), e.g., Police, Department of Transportation, National Security Agency, Homeland Security Office (HSO), or officer from such an organization. When, as is often the case, these messages will be distributed at large and may result is a general response from the public, it may be important to insure the security/authenticity of the messages and thus the PSO may encrypt the message, using for example a private key, such as the HSO private key or other encryption key. Thus, optionally, 305 includes decrypting, with a corresponding public key or the like, the user level information message and otherwise validating the message.

Next the optional process 307 converts the message to information corresponding to the user level information message. The process 307 may not be required if the user level information message from, for example, the PSO is already in the proper form or includes the appropriate corresponding information or the user level information message in a raw or encrypted form can be used in further processes 309, 311. This conversion can provide or result in a Scrambling Code Group (SCG) that is given or takes a value that is not otherwise used for normal communications in the corresponding cellular system, e.g., W-CDMA cellular system. For example, in W-CDMA systems as presently defined, SCGs having values equal to or less than 63 are authorized and used for normal communications. Thus an SCG having a value greater than 63 can be used, for example, to identify a class of the user level information messages. For example, 64 can correspond to a Tornado warning, 65 to a Biological Terror threat, 66 to a Nuclear threat, 67 et. sequence to other forms of user level information message or emergency messages and the like. Conversion of the message may also include encrypting the information using for example a private key, e.g., HSO private key or other private key, and thus result in providing encrypted content. Note that raw content appropriately parsed and the like may also be provided. Sources of additional information can be made available as a result of the conversion or similar translation process, e.g., a phone number or website (Uniform Resource Locator, etc.) can be provided for embedding as discussed below.

Once the user level information message or the corresponding information is in the proper form either as converted at 307 or as originally obtained, embedding the information (indication of the user level information message) is performed 309. Thus in various embodiments, the method 300 includes embedding information corresponding to the user level information message in an overhead communication, such as an access or synchronization communication. This can include embedding information corresponding to an emergency warning message in the overhead communication.

Note, in some embodiment, embedding the information in a synchronization communication further comprises embedding an indication of the user level information message as a scrambling code group for a Code Division Multiple Access (CDMA) cellular system. The embedding an indication of the user level information message as a scrambling code group can further include embedding the indication of the user level information message as a scrambling code group with a value exceeding 63, where, for example, a particular value corresponds to a particular class of message, e.g., weather alert, terror alert, biological alert, etc.

In other embodiments, the embedding the information in a synchronization communication further includes embedding content, encrypted content (encrypted emergency warning message, etc.), phone numbers or URLs or additional information, corresponding to the user level information message in the synchronization communication for a synchronization channel in a Global System for Mobile (GSM) cellular system. The embedding content, etc. corresponding to the user level information message in the synchronization communication for a synchronization channel may include substituting the content for synchronization information in the synchronization communication according to a predetermined schedule, e.g. every other, every third, every 10^{th}, or the like synchronization package or information.

After the user level information message or corresponding indication or information is embedded in a communication or data stream for an overhead or access channel, the method includes broadcasting at 311 the overhead communication including the information in accordance with a protocol for one or more overhead channels in a cellular system. For example, broadcasting the overhead communication can include broadcasting the synchronization communication in accordance with a protocol for one or more synchronization channels in a cellular system. Note that the process of broadcasting the overhead communication can include broadcasting the overhead communication from one or more base transmitters 107, 113 in a cellular system. Alternatively, the broadcasting the overhead communication can include broadcasting the overhead communication from one or more transmitters 211, 217, 221 that are not part of the cellular system. Note that obtaining the user level information message can include a command for initiating the conversion and embedding information corresponding to the user level information message, and the broadcasting the overhead communication or these processes can be volitionally initiated in response to obtaining the user level information message.

After the broadcasting at 311, the communications or broadcasted signal is received 313 at, for example, one or more of the communication units 111. Then, at 315, this signal is processed to determine whether embedded information corresponding to a user level information message is present, e.g., signal or data is parsed, decrypted, etc. to determine whether an emergency message is present. If an embedded signal is present, it can be processed to provide a message for presentation to a user of the communication unit that received the broadcasted signal, for example, on a user interface 317. The method then ends 319 but may be repeated as needed.

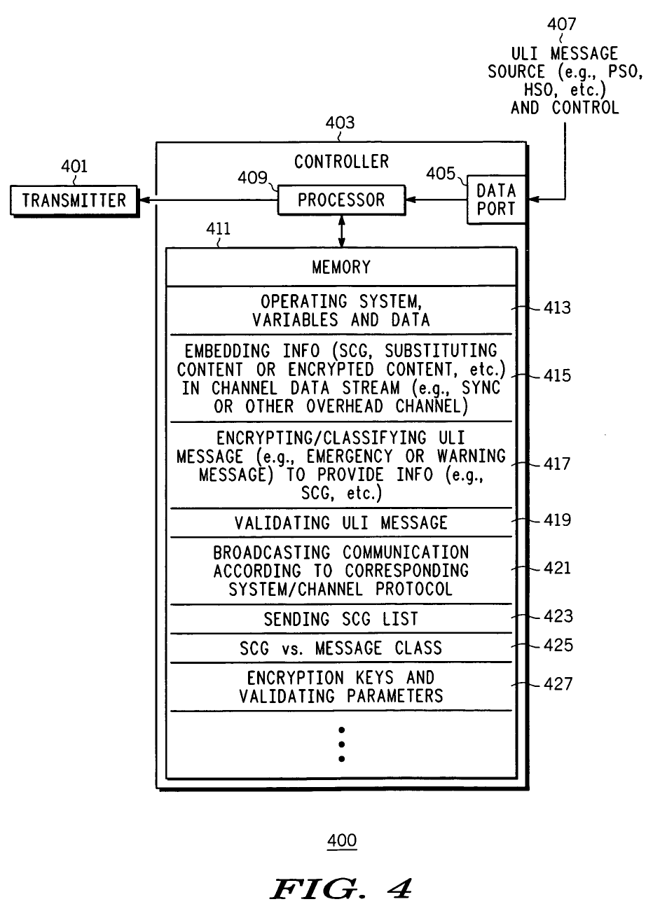

FIG. 4 depicts an exemplary block diagram of a transmitting unit 400 or transmitter, similar to the transmitters 107, 113, 211, 217, 221, that is configured to deliver user level information messages, using for example, one or more channels corresponding to or in accordance with cellular channels. The transmitting unit 400 includes a transmitter 401 coupled to a controller 403 that is further coupled via a data port 405 and one or more known techniques to a source of user level information messages 407, e.g. PSO, HSO, etc. or corresponding apparatus, such as a public safety communication unit or radio 207 as well as possibly a source of control instructions.

The controller 403 includes a processor 409 inter coupled to and possibly integrated with a memory 411 and may include various other functionality that need not be discussed. The processor 409 has one or more general purpose micro-processors or digital signal processors as well as various supporting circuitry that is known and may vary with the operational specifics as well as requisite and number of protocols and corresponding channels that are supported.

The memory 411 includes one or more RAM, ROM, PROM, EEPROM, Magnetic, Optical, or the like memory technologies. Various software routines and the like are stored in the memory 411. These routines include an Operating system, variables and data routine 413 and a routine 415 for Embedding information (e.g., SCG, substituting content, encrypted content, etc.) in a channel data stream, e.g., Sync or other access/overhead channel. Further included is an encrypting/classifying routine 417 for processing user level information messages (e.g., emergency warning messages, etc.) to provide corresponding information or indications, e.g., SCGs, etc. and a validating user level information message routine 419 to verify that a user level information message at the data port is from an authorized source. Additionally included are one or more routines 421 directed to broadcasting communications or data streams according to corresponding system/channel protocols. There is an additional routine 423 in some embodiments that may be used to send an SCG list including those routines that should be monitored (sometimes referred to as a CELL_INFO_LIST in some systems). Further shown are database(s) 425 with SCG cross referenced to message classes and database 427 with encryption keys and validating parameters.

The processor executes software instructions stored in the memory and thereby results in the controller 403 managing the operation and functionality of the transmitting unit 400 including receiving and processing user level information messages, providing appropriate data streams or signals to and cooperatively with the transmitter delivering the user level information messages as signals having protocols according to one or more overhead or access channels in, for example, a cellular system.

In operation, the transmitting unit 400 is configured for delivering a user level information message using cellular channels and includes the data port 405 configured to receive the user level information message (e.g., an emergency warning message) and possibly decrypt and validate using the routines 417, 419. Further included is the processor 409 coupled to the data port and arranged to provide a data stream with embedded information (e.g., SCG, substituting content or encrypted content, phone number or URL for normal sync data) corresponding to the user level information message in accordance with a protocol for one or more overhead or access channels using the embedding routine(s) 415 and encrypting/classifying routines 417, e.g. one or more synchronization channels, in a cellular system. Additionally included is the transmitter 401, coupled to and cooperatively operable with the processor 409 and the broadcasting routine 421, that is configured to transmit or broadcast a signal including the data stream on the one or more overhead channels.

Thus the data port 405 is configured to receive an emergency warning message and the processor 409 is arranged to provide the data stream with embedded information corresponding to the emergency warning message. The processor 409 can be configured to provide the data stream with embedded information corresponding to the user level information message in accordance with a protocol for one or more synchronization channels in a cellular system and the transmitter can be configured to transmit a signal including the data stream on the one or more synchronization channels.

The processor 409 can also be configured to provide the data stream with embedded information further including an indication of the user level information message as a scrambling code group (SCG) having a value that is not otherwise used for a Code Division Multiple Access (CDMA) cellular system, e.g. a value exceeding 63 where a particular value corresponds to a class of message. As earlier noted, the processor 409 can also be configured to provide the data stream with embedded information further including content corresponding to the user level information message where the content is substituted, according to a predetermined schedule, for synchronization data for a synchronization channel in a Global System for Mobile (GSM) cellular system. The transmitting unit can be configured to operate independently from a cellular system, e.g. in conjunction with a vehicle or as a base transmitter in the cellular system.

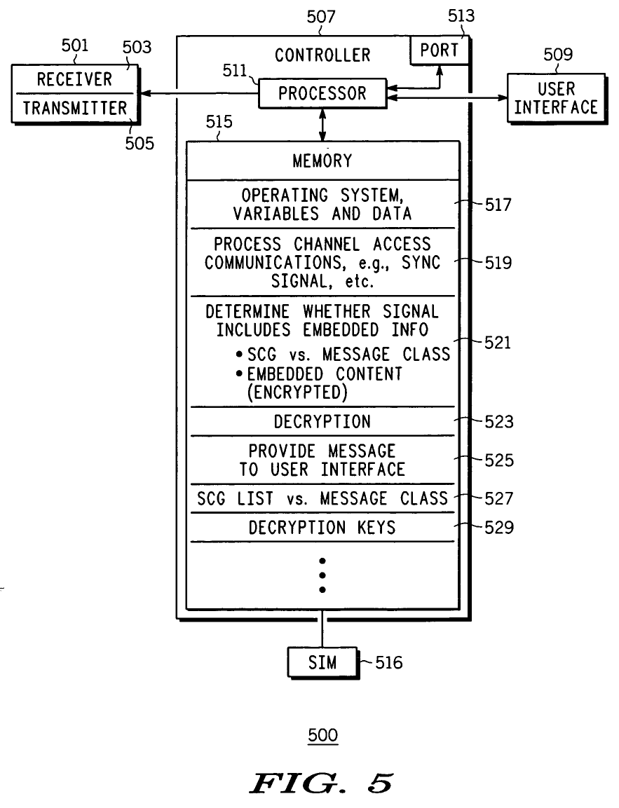

FIG. 5 depicts an exemplary block diagram of a communication unit 500 for receiving user level information messages, such as the messages that are delivered, transmitted, or broadcasted from the transmitting unit of FIG. 4. The communication unit of FIG. 5 is structurally similar to known cellular handsets or telephones and the structure will only be briefly mentioned. Generally the communication unit includes a transceiver 501, specifically one or more receivers 503 and possibly transmitters 505 that are coupled to a controller 507 with the controller 507 further coupled to a known user interface 509 (e.g., speaker, microphone, keys, etc.). The controller includes a processor 511 with one or more microprocessors or digital signal processors that is coupled to and possibly integrated with a memory 515 and an optional port 513 that may be used to couple to external devices, such as peripherals, portable computers, and the like. The memory stores software instructions and data that when used and executed by the processor 511 results in the controller controlling and managing the functions of the communication unit 500.

The memory includes one or more of RAM, ROM, PROM, EEPROM, and the like memory technologies. Note that a portion of this memory can be external memory, e.g., a subscriber identity module (SIM) 516 Various routines are included in the memory including as depicted operating system, variables, and data 517 that provide the overall management for the software executed by the processor 511. Other routines included are a processing routine 519 that processes channel access or overhead communications or signals, such as synchronization signals and data that are received by the receiver(s) 503; routine 521 for determining whether a signal that has been received includes embedded information or an indication of a user level information message, e.g. an SCG corresponding to a message class, or embedded content; a Decryption routine 523 for decrypting any embedded information if need be; and one or more routines 525 for providing messages to the user interface 509 or presenting the messages on the user interface. Further included in the memory 515 are various databases including a database 527 that lists SCGs and corresponding message classes and decryption keys database 529.

In operation, the communication unit 500 is arranged to receive a user level information message, such as an emergency warning message using cellular channels or channels corresponding to normal cellular channels. In overview, the transceiver 501 is configured to receive, for example, a synchronization signal on a channel corresponding to a cellular system. The controller 507 is coupled to the receiver 503 and configured to process using routines 519, 521 the synchronization signal to determine whether the synchronization signal includes embedded information corresponding to an emergency message and, if so, to provide, using routine 525, the emergency warning message to the user interface 509. The user interface 509 is configured to present the emergency message to a user of the communication unit 500.

Thus the controller 507, specifically processor 511 and software routines 519, 521 can be configured to process, for example, a synchronization signal to determine whether the embedded information comprises a scrambling code group having a value that is not otherwise used for a Code Division Multiple Access (CDMA) cellular system, e.g., SCG>63 for a Wideband CDMA (W-CDMA) system, where the particular value corresponds to a class of emergency messages according to the database 527. The receiver 503 is configured to receive a signal comprising one or more scrambling code groups corresponding to one or more classes of emergency warning messages.

In other embodiments, the controller 507 can be configured to process the synchronization signal to determine whether the embedded information comprises content corresponding to the emergency message where the content is substituted, according to a predetermined schedule, for synchronization data associated with a synchronization channel in a Global System for Mobile (GSM) cellular system. The controller 507 can be configured to decrypt the embedded information using decryption routine 523 and the appropriate key from the database 529. Note that the Subscriber Identification Module (SIM) 516 may be an advantageous location to store the decryption keys and thus the controller would be configured to access the SIM to obtain a key to use in decrypting the embedded information to provide the emergency message. It is further noted that the communication unit 500 is suitable to perform various other functions as described above and as will be evident in view of the concepts and principles discussed.

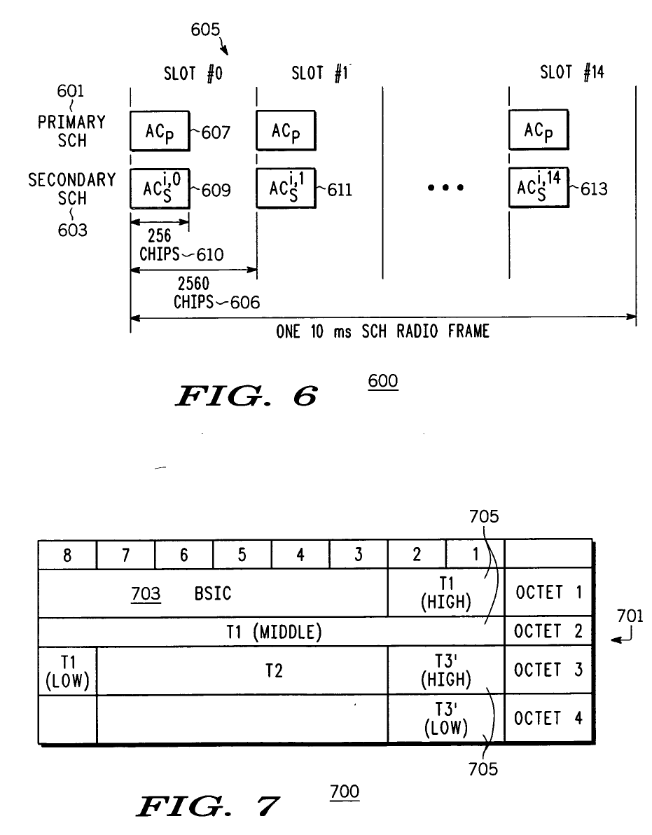

While the general concepts that have been described can be applied to many cellular systems as well as other subscriber populations, a few specific examples will be provided for each of a W-CDMA system as well as a GSM system. FIG. 6 shows a synchronization protocol structure 600 for a Wideband Code Division Multiple Access (W-CDMA) system as defined by the 3^{rd} Generation Partnership Project (3GPP) standards body in one or more standards documents. In W-CDMA, each cell, e.g., service area for a BTS, is designated with a particular Scrambling Code Number (SCN) from a maximum of 512 numbers (0 to 511). Each SCN is 38,400 chips long. The 38,400 chips form a 10 milli-second radio frame, which is divided into 15 slots 605 of 2,560 chips 606 each. Each of these 512 SCNs belongs to a particular Scrambling Code Group (SCG) from a maximum of 64 groups (0 to 63).

Thus, as noted above, SCGs having values greater than 63, can be used to indicate an emergency message or situation, with each of these SCGs corresponding to a particular emergency code or class of user level information message, e.g., emergency message. When a communication unit (referred to alternatively as a user equipment (UE)) decodes such a SCG, it can notify the user of the particular emergency code or class of message. The decoding of the SCG is achieved through the standard cell synchronization procedure in W-CDMA (alternatively UMTS). The cell synchronization procedure to identify a particular cell (i.e., the particular SCN for that cell) involves 3 processes, of which only the first two are necessary for an approach discussed in this disclosure below. At the end of the second process, the UE identifies the particular SCG.

UMTS base stations use the synchronization channels—Primary Synchronization Channel (P-SCH) 601 and the Secondary Synchronization Channel (S-SCH) 603 for transmitting the synchronization code sequences to and thus receiving the codes at the UEs. The P-SCH 601 consists of a modulated code 607 of length 256 chips 610, with the Primary Synchronization Code (PSC) denoted cp in FIG. 6. The PSC is the same for all the base stations (BTS) or cells in the system and is transmitted at the beginning of every slot. All the base stations use the same sequence, so a single matched filter enables the detection of the slot boundary value.

The S-SCH 603 carries the sequences corresponding to the particular SCG (i.e., one of 0-63) in every slot of a frame. The S-SCH consists of repeatedly transmitting a length 15 sequence of modulated codes of length 256 chips, where the Secondary Synchronization Codes (SSC) are transmitted in parallel with the P-SCH. The SSC is denoted cₛ^{i,k} 609, 611, 613, where i=0, 1, . . . , 63 is the number of the scrambling code group, and k=0, 1, . . . , 14 is the slot number. Each SSC is chosen from a set of 16 different codes of length 256. This sequence on the Secondary SCH indicates which of the code groups the cell's downlink scrambling code belongs to. The primary and secondary synchronization codes are modulated by the symbol a shown in FIG. 6. Hence the SCG is decoded in 2 steps: a) Slot Synchronization: This is achieved by using the P-SCH Frame Synchronization and b) SCG decoding: This is achieved by using the S-SCH and correlating the received signal with all the possible SSC sequences. This mechanism of decoding the SCG and a set of new SCGs with values greater than 63, are employed by one or more embodiments to decode the new SCGs, i.e., SCGs>63, where each of these SCGs greater than 63 have a one-to-one mapping with different classes of messages or emergency messages. For example, 64 can correspond to Tornado, 65 to Bio/chemical, 66 to Nuclear, 67 to other, etc.

Another aspect of this proposal is to make sure that the UEs try to detect these new SCGs when needed and also, to make sure that the UEs do not try to detect them when not needed. The UEs may be designed to detect only those SCGs that are needed to detect the SCNs in the known CELL_INFO_LIST. In order that the UEs attempt to detect the new SCGs, the UEs will need to get an updated CELL_INFO_LIST. The mechanisms for updating this CELL_INFO_LIST are different for the different states that a UE can possibly be in, and are defined by the 3GPP specifications. These techniques for updated the SCG list only work when the network or system is functional. In the case of the network being non-functional, obviously the CELL_INFO_LIST cannot be updated in the normal fashion and the UEs would need to execute a selection algorithm, such as look for new SCGs when normal SCGs are not detected in order to decode the appropriate SCG.

FIG. 7 shows a synchronization data or information structure (SCH) 700 for a Global System for Mobile (GSM) system. Various approaches for embedding a user level information message or emergency warning message are contemplated for GSM systems and both rely on using the four octets 701 in the SCH information or data. Normally the four octets include 6 bits for a base station identifier code (BSIC) 703 plus other bits (T1(high), T1(middle), T1(low) T2, T3′(high), and T3′(low)) that can be used to determine a radio frame number as is known. One approach substitutes an indication of the user level information message, e.g. class of the message, or a portion of the message in bits 1 and 2 from the first 3 octets and bit 1 from the fourth octet, for a total of seven (7) bits 705 out of each possible thirty two (32) bits in the SCH information or data to define a value (from 0-127) corresponding, for example, to a class of emergency message. Note that these bits in the known GSM protocol are normally devoted to reduced frame number information, which will not normally be needed in an emergency situation. This value can also be encrypted, e.g., using a PSO private key, which may result in less range for raw data given encryption overhead but would still be sufficient to provide an indication within a particular SCH data for varying classes of emergency messages. Note also that 7 bits is sufficient for sending ASCI encoded alphanumeric data, with one character in each SCH data location. As an alternative all bits in the SCH data can be used for the user level information message, i.e. content is substituted for normal SCH information, provided only a percentage of all of the SCHs are so utilized. It is anticipated that a unique flag or indicator would be included in one or more SCHs to trigger a UE to specially process other bits in a given SCH or other SCHs. For example, if the bits in the BSIC 703 were all set to one, e.g., 111111, or alternatively if the bits in the first octet were set to 10101010, or some other predetermined pattern for some portion of the SCH, one of these unique patterns could be used to trigger UEs to appropriately process the user level information messages.

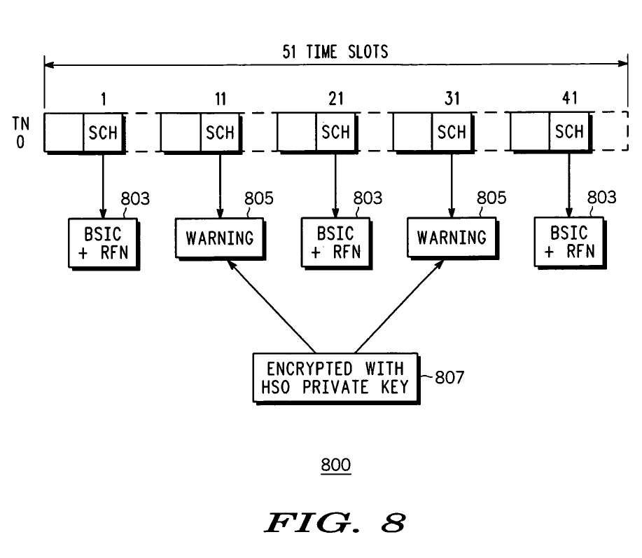

FIG. 8 shows a data frame 800 according to a known protocol for a GSM system, the data frame comprising 51 time slots (0-50). As reflected in FIG. 8, the SCH data is repeated in every tenth slot (slots 1, 11, 21, 31, and 41), i.e. five times in each GSM data frame 800. By concatenating SCH data with embedded information in the seven bits, as discussed with reference to FIG. 7, from sequential or a predetermined pattern of subsequent SCH slots, the size of the user level information message or emergency message can be enlarged more or less arbitrarily to include some content as well as a phone number or URL where recipients may obtain additional information. For example, each occurrence of SCH data can include a modified SCH carrying a portion of the embedded information. Alternatively, as shown in FIG. 8, slots 1, 21, 41 can carry normal SCH data comprising a base station ID codes and a radio frame number 803, with the other SCH data slots 805 including embedded indications or portions of a user level information message, e.g., warning message. These slots 805 can be encrypted 807 with an HSO or the like private key, where again these slots can be used in part (7 bits) or in total as earlier noted.

The processes, apparatus, and systems, discussed above, and the inventive principles thereof are intended to and will alleviate problems caused by prior art emergency warning schemes. Using these principles of embedding user level information messages or indications of user level information messages, such as emergency warning messages within channels that otherwise correspond to protocols for normal overhead or access channels that all communication units are expected to monitor will enhance the availability of important information, such as emergency warning information to the public at large given the high percentage of individuals that now utilize some form of personal communication device.

This disclosure is intended to explain how to fashion and use various embodiments in accordance with the invention rather than to limit the true, intended, and fair scope and spirit thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. Many such modifications and variations are within the scope of the invention as determined by the appended claims, as may be amended during the pendency of this application for patent, and all equivalents thereof, when interpreted in accordance with the breadth to which they are fairly, legally, and equitably entitled.

What is claimed is:

1. A method of delivering user level information over a communication system, the method comprising:
embedding user level information in a wireless system control message; and
broadcasting the wireless system control message in accordance with a protocol for one or more control messages in a wireless communication system.

2. The method according to claim 1 wherein the broadcasting the wireless system control message further comprises broadcasting the wireless system control message in accordance with a protocol for one or more control messages in a cellular system.

3. The method according to claim 1 wherein the embedding user level information further comprises embedding a pointer to user perceptible information in the wireless system control message.

4. The method according to claim 1 wherein the embedding user level information further comprises embedding encrypted user level information in the wireless system control message.

5. The method according to claim 1 wherein the embedding user level information further comprises embedding information corresponding to at least one of an emergency message and a pointer to an emergency message in the wireless system control message.

6. The method according to claim 1 wherein the embedding user level information further comprises embedding the user level information in a synchronization message and the broadcasting the wireless system control message further comprises broadcasting the synchronization message in accordance with a protocol for one or more synchronization channels in a cellular system.

7. The method according to claim 6 wherein the embedding the user level information in a synchronization message further comprises embedding an indication of a user level information message as a scrambling code group for a Code Division Multiple Access (CDMA) cellular system.

8. The method according to claim 7 wherein the embedding an indication of the user level information message as a scrambling code group further comprises embedding the indication of the user level information message as a scrambling code group with a value exceeding the protocol maximum SCG value, where a particular value corresponds to a particular class of user level information message.

9. The method according to claim 6 wherein the embedding the user level information in a synchronization message further comprises embedding at least one of a pointer to user level content and a user level information message in the synchronization message for a synchronization channel in a Global System for Mobile (GSM) cellular system.

10. The method according to claim 9 wherein the embedding at least one of a pointer to user level content and a user level information message in the synchronization message for a synchronization channel further comprises substituting the at least one of a pointer to user level content and a user level information message for synchronization information in the synchronization message according to a predetermined schedule.

11. The method according to claim 9 wherein the embedding at least one of a pointer to user level content and a user level information message in the synchronization message further comprises embedding an encrypted emergency message in the synchronization message.

12. The method according to claim 1 wherein the broadcasting the wireless system control message further comprises broadcasting the wireless system control message from one or more base transmitters in the wireless communication system.

13. The method according to claim 1 wherein the broadcasting the wireless system control message further comprises broadcasting the wireless system control message from one or more transmitters that are separate from the wireless communication system.

14. The method according to claim 1 further comprising obtaining the user level information from a public safety organization and initiating, responsive thereto, the embedding user level information and the broadcasting the wireless system control message.

15. The method according to claim 1 wherein the embedding user level information further comprises embedding a pointer to user readable sources of information comprising at least one of a Universal Record Locator (URL) and emergency center phone number.

16. A transmitting unit for delivering a user level information message using cellular channels, the transmitting unit comprising:
a data port configured to receive the user level information message;
a processor coupled to the data port and arranged to provide a data stream with embedded information corresponding to the user level information message in accordance with a protocol for one or more overhead channels in a cellular system; and
a transmitter coupled to the processor and configured to transmit a signal including the data stream on the one or more overhead channels.

17. The transmitting unit of claim 16 wherein the data port is configured to receive an emergency message and the processor is arranged to provide the data stream with embedded information corresponding to the emergency message.

18. The transmitting unit of claim 16 wherein the processor is further configured to provide the data stream with embedded information corresponding to the user level information message in accordance with a protocol for one or more synchronization channels in a cellular system and the transmitter is further configured to transmit a signal including the data stream on the one or more synchronization channels.

19. The transmitting unit of claim 18 wherein the processor is further configured to provide the data stream with embedded information further comprising an indication of the user level information message as a scrambling code group having a value that is not otherwise used for a Code Division Multiple Access (CDMA) cellular system.

20. The transmitting unit of claim 18 wherein the processor is further configured to provide the data stream with embedded information further comprising content corresponding to the user level information message where the content is substituted, according to a predetermined schedule, for synchronization data for a synchronization channel in a Global System for Mobile (GSM) cellular system.

21. The transmitting unit of claim 16 configured to operate independently from a cellular system.

22. The transmitting unit of claim 16 configured to operate as a base transmitter in the cellular system.

23. A communication unit arranged to receive an emergency message using cellular channels, the communication unit comprising:
a receiver configured to receive a synchronization signal on a channel corresponding to a cellular system;
a controller coupled to the receiver and configured to process the synchronization signal to determine whether the synchronization signal includes embedded information corresponding to the emergency message; and
a user interface coupled to the controller and configured to present the emergency message to a user of the communication unit.

24. The communication unit of claim 23 wherein the controller is further configured to process the synchronization signal to determine whether the embedded information comprises a scrambling code group having a value that is not otherwise used for a Code Division Multiple Access (CDMA) cellular system, the value corresponding to a class of emergency messages.

25. The communication unit of claim 24 wherein the receiver is further configured to receive a signal comprising one or more scrambling code groups corresponding to one or more classes of emergency messages.

26. The communication unit of claim 23 wherein the controller is further configured to process the synchronization signal to determine whether the embedded information comprises content corresponding to the emergency message where the content is substituted, according to a predetermined schedule, for synchronization data associated with a synchronization channel in a Global System for Mobile (GSM) cellular system.

27. The communication unit of claim 23 wherein the controller is further configured to decrypt the embedded information.
